(19) United States
(12) Patent Application Publication
(10) Pub. No.: US 2011/0267264 A1
(43) Pub. Date: Nov. 3, 2011

(54) DISPLAY SYSTEM WITH MULTIPLE OPTICAL SENSORS

(76) Inventors: John McCarthy, Pleasanton, CA (US); John J. Briden, San Francisco, CA (US); Bradley N. Suggs, Sunnyvale, CA (US)

(21) Appl. No.: 12/770,637

(22) Filed: Apr. 29, 2010

(51) Int. Cl. G09G 5/08

(52) U.S. Cl. 345/157

(57) ABSTRACT

Embodiments of the present invention disclose a multi-camera system for a display system. According to one embodiment, the display system includes a display panel configured to display images on a front side, and at least three three-dimensional optical sensors arranged around the perimeter of the display panel. Furthermore, each three-dimensional optical sensor is configured to capture measurement data of an object from a perspective different than the perspective of the other optical sensors.

### BACKGROUND

Providing efficient and intuitive interaction between a computer system and users thereof is essential for delivering an engaging and enjoyable user-experience. Today, most computer systems include a keyboard for allowing a user to manually input information into the computer system, and a mouse for selecting or highlighting items shown on an associated display unit. As computer systems have grown in popularity, however, alternate input and interaction systems have been developed. For example, touch-based, or touchscreen, computer systems allow a user to physically touch the display unit and have that touch registered as an input at the particular touch location, thereby enabling a user to interact physically with objects shown on the display. Due to certain limitations of conventional optical systems, however, a user's input or selection may be not be correctly or accurately registered by the computing system.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are three-dimensional perspective views of a multi-camera computing system according to an embodiment of the present invention.

FIG. 2 is a simplified block diagram of the multi-camera system according to an embodiment of the present invention.

FIG. 3 depicts an exemplary three-dimensional optical sensor according to an embodiment of the invention.

FIG. 4 illustrates a perspective view of the multi-camera system and exemplary field of views of the optical sensors according to an embodiment of the present invention.

FIGS. 5A-5D illustrate alternative configurations of the multi-camera system according to embodiments of the present invention.

FIG. 6 illustrates the processing steps for the multi-camera system according to an embodiment of the present invention

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct electrical connection, or through an indirect electrical connection via other components and connections, such as an optical electrical connection or wireless electrical connection. Furthermore, the term “system” refers to a collection of two or more hardware and/or software components, and may be used to refer to an electronic device or devices, or a sub-system thereof.

### DETAILED DESCRIPTION OF THE INVENTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Conventional touchscreen and optical solutions are limited by certain occlusion issues. Occlusion occurs when an object touching the screen is blocked (or occluded) from view by another object. In other words, by nature, an optical touch screen solution must be able to see the object touching the screen to accurately register a touch from a user. Most two camera systems are configured to only detect two touches and are also limited in the cases in which they can reject a palm touching the screen (i.e. palm rejection capability). Such few factors limit the effectiveness of touchscreen computing environments utilizing conventional optical solutions.

Embodiments of the present invention disclose a multi-camera system for an electronic display device. According to one embodiment, the multi-camera system includes at least three three-dimensional cameras arranged around the perimeter of the display panel of the computing device. In one embodiment, the multi-camera system includes at least three optical sensors each configured to capture measurement data of an object from a different perspective with respect to the display panel.

Furthermore, a multi-camera system in accordance with embodiments of the present invention has a number of advantages over more traditional camera systems. For example, the solution proposed by embodiments of the present invention provide improved multi-touch performance, improved palm rejection capabilities, improved three-dimensional object mapping, and improved cost effectiveness. According to one embodiment, the multi-camera system will be able to detect a minimum number of touches equal to the number of optical sensors and without any occlusion issues. As the number of optical sensors increases, it becomes even harder to occlude the desired touch implemented with the palm. Furthermore, as the camera system also has the ability to detect three-dimensional objects in the space in front of the display unit, more optical sensors will allow the system to generate a much more detailed three-dimensional model of the object. The lack of occlusion also allows for added accuracy for fewer touch points and the potential for many more than two touches in many scenarios.

Moreover, due to the numerous viewpoints and perspectives of the multi-camera system of the present embodiments, palm rejection capability is greatly improved. In particular, the palm area of a user can land on the display screen in far fewer locations that would occlude the desired intended touch of the user. Still further, another advantage of providing at least three three-dimensional optical sensors over other touch screen technologies is the ability of each optical camera to scale data extremely inexpensively.

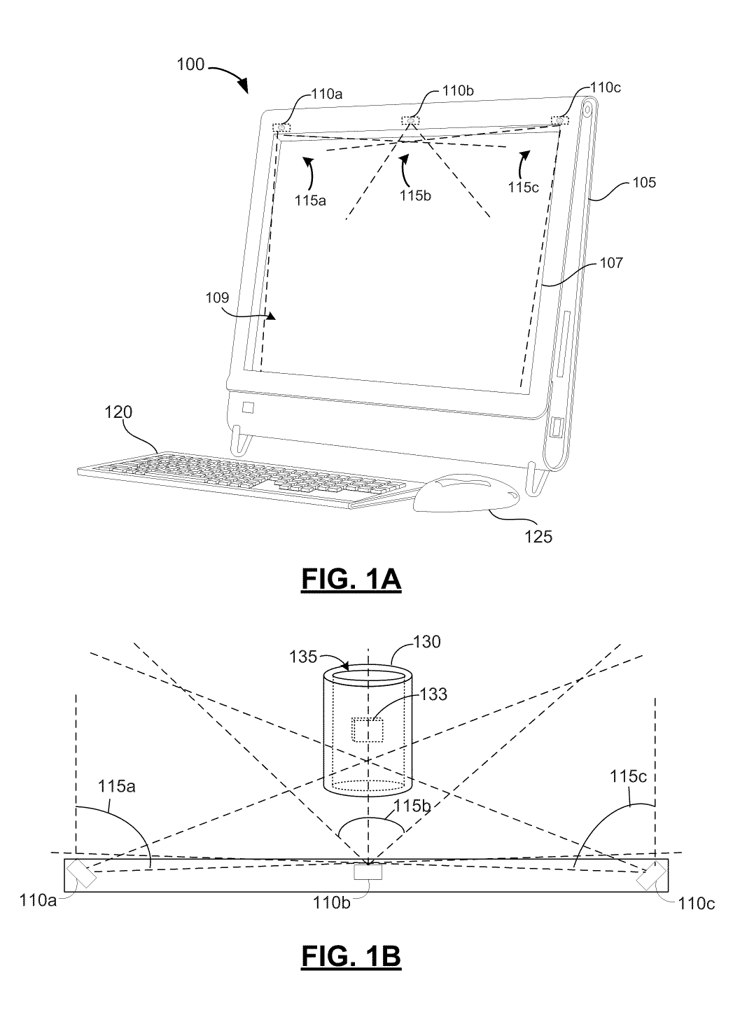

Referring now in more detail to the drawings in which like numerals identify corresponding parts throughout the views, FIG. 1A is a three-dimensional perspective view of an all-in-one computer having multiple optical sensors, while FIG. 1B is a top down view of a display device and optical sensors including the field of views thereof according to an embodiment of the present invention. As shown in FIG. 1A, the system 100 includes a housing 105 for enclosing a display panel 109 and three three-dimensional optical sensors 110a, 110b, and 110c. The system also includes input devices such as a keyboard 120 and a mouse 125 for text entry, navigating the user interface, and manipulating data by a user.

The display system 100 includes a display panel 109 and a transparent layer 107 in front of the display panel 109. The front side of the display panel 109 is the surface that displays an image and the back of the panel 109 is opposite the front. The three dimensional optical sensors 110a-110c can be on the same side of the transparent layer 107 as the display panel 109 to protect the three dimensional optical sensors from contaminates. In an alternative embodiment, the three dimensional optical sensors 110a-110c may be in front of the transparent layer 105. The transparent layer 105 can be glass, plastic, or another transparent material. The display panel 109 may be a liquid crystal display (LCD) panel, a plasma display, a cathode ray tube (CRT), an OLED or a projection display such as digital light processing (DLP), for example. In one embodiment, mounting the three dimensional optical sensors 110a-110c in an area of the display system 100 that is outside of the perimeter of the of the display panel 109 provides that the clarity of the transparent layer is not reduced by the three dimensional optical sensors.

Three-dimensional optical sensors 110a, 110b and 110c are configured to report a three-dimensional depth map to a processor. The depth map changes over time as an object 130 moves in the respective field of view 115a of optical sensor 110a, the field of view 115b of optical sensor 115b, and the field of view 215b of optical sensor 210b. The three-dimensional optical sensors 110a-110c can determine the depth of an object located within its respective field of view 115a-115c. The depth of the object 130 can be used in one embodiment to determine if the object is in contact with the front side of the display panel 109. According to one embodiment, the depth of the object can be used to determine if the object is within a programmed distance of the display panel but not actually contacting the front side of the display panel. For example, the object 130 may be a user's hand and finger approaching the front side of the display panel 109. In one embodiment, optical sensors 110a and 110c are positioned at top most corners around the perimeter of the display panel 109 such that each field of view 115a - 115c includes the areas above and surrounding the display panel 109. As such, an object such as a user's hand for example, may be detected and any associated motions around the perimeter and in front of the computer system 100 can be accurately interpreted by the processor.

Furthermore, inclusion of three optical sensors 110a-110c allows distances and depth to be measured from the viewpoint/perspective of each sensor (i.e. different field of views and perspectives), thus creating a stereoscopic view of the three-dimensional scene and allowing the system to accurately detect the presence and movement of objects or hand poses. For example, and as shown in the embodiment of FIG. 1B, the perspective created by the field of view 115a of optical sensor 110a would enable detection of depth, height, width, and orientation of object 130 at its current inclined position with respect to a first reference plane. Furthermore, a processor may analyze and store this data as measurement data to be associated with detected object 130. Due to the angled viewpoint and field of views 115a, 115c of optical sensors 110a and 110c, these optical sensors may be unable to capture the hollowness of object 130 and therefore recognize object 130 as only a cylinder in the present embodiment. Furthermore, the positioning and orientation of object 130 with respect to optical sensors 110a and 110c serves to occlude the field of views 115a and 115c from capturing measurement data of cube 133 within object 130. Nevertheless, the perspective afforded by the field of view 115b will enable optical sensor 110b to detect the depth and cavity 135 within object 130 using a second reference plane, thereby recognizing object 130 as a tubular-shaped object rather than a solid cylinder. Still further, the inclusion of optical sensor 110b and the associated field of view 115b allows the display system to detect cube 133 resting within the cavity 135 of the object 130. Therefore, the differing field of views and differing perspectives of all three optical sensors 110a-110c work together to recreate a precise three-dimensional map and image of the detected object 130 so as to drastically reduce the possibility of object occlusion.

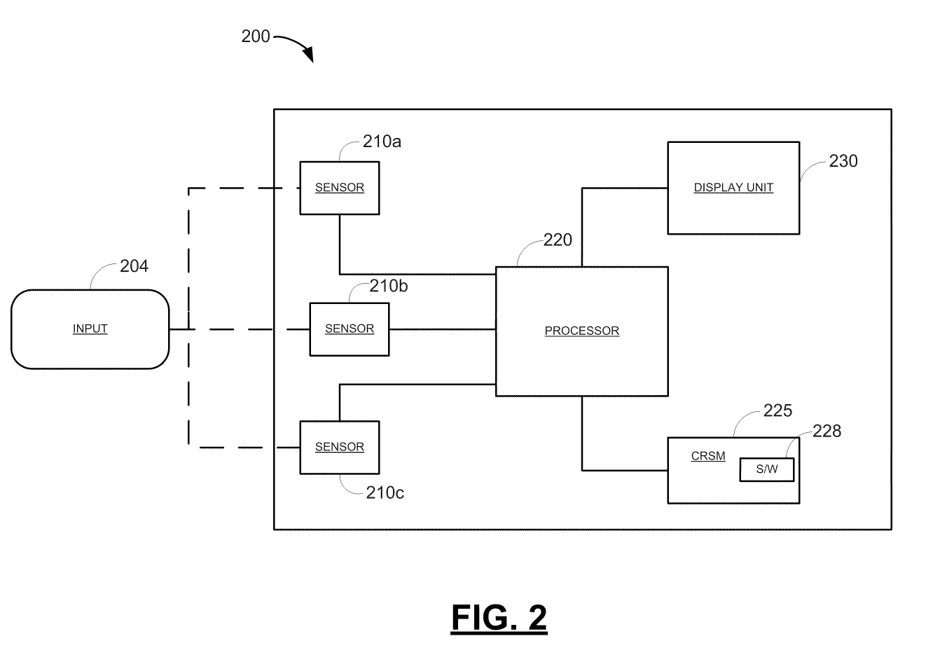

FIG. 2 is a simplified block diagram of the multi-camera system according to an embodiment of the present invention. As shown in this exemplary embodiment, the system 200 includes a processor 220 coupled to a display unit 230, a computer-readable storage medium 225, and three three-dimensional optical sensors 210a, 210b, and 210c configured to capture input 204, or measurement data related to an object in front of the display unit 230. In one embodiment, processor 220 represents a central processing unit configured to execute program instructions. Display unit 230 represents an electronic visual display or touch-sensitive display such as a desktop flat panel monitor configured to display images and a graphical user interface for enabling interaction between the user and the computer system. Storage medium 225 represents volatile storage (e.g. random access memory), non-volatile store (e.g. hard disk drive, read-only memory, compact disc read only memory, flash storage, etc.), or combinations thereof Furthermore, storage medium 225 includes software 228 that is executable by processor 220 and, that when executed, causes the processor 220 to perform some or all of the functionality described herein.

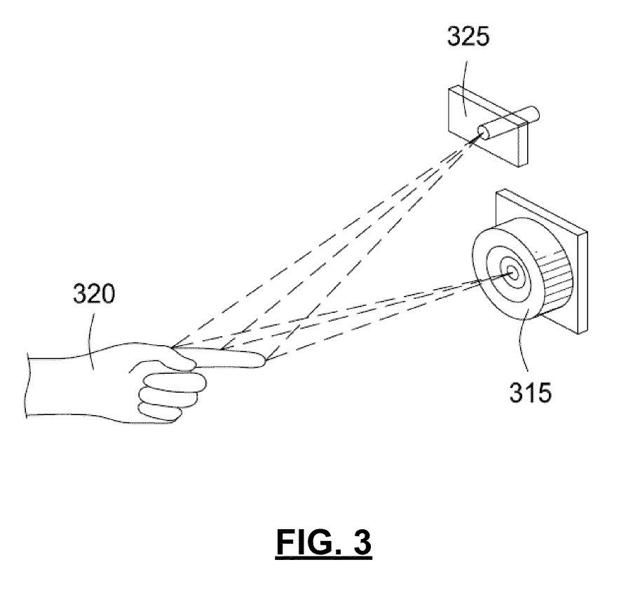

FIG. 3 depicts an exemplary three-dimensional optical sensor 315 according to an embodiment of the invention. The three-dimensional optical sensor 315 can receive light from a source 325 reflected from an object 320. The light source 325 may be an infrared light or a laser light source for example, that emits light and is invisible to the user. The light source 325 can be in any position relative to the three-dimensional optical sensor 315 that allows the light to reflect off the object 320 and be captured by the three-dimensional optical sensor 315. The infrared light can reflect from an object 320 that may be the user's hand in one embodiment, and is captured by the three-dimensional optical sensor 315. An object in a three-dimensional image is mapped to different planes giving a Z-order, order in distance, for each object. The Z-order can enable a computer program to distinguish the foreground objects from the background and can enable a computer program to determine the distance the object is from the display.

Conventional two-dimensional sensors that use a triangulation based methods may involve intensive image processing to approximate the depth of objects. Generally, two-dimensional image processing uses data from a sensor and processes the data to generate data that is normally not available from a two-dimensional sensor. Color and intensive image processing may not be used for a three-dimensional sensor because the data from the three-dimensional sensor includes depth data. For example, the image processing for a time of flight using a three-dimensional optical sensor may involve a simple table-lookup to map the sensor reading to the distance of an object from the display. The time of flight sensor determines the depth from the sensor of an object from the time that it takes for light to travel from a known source, reflect from an object and return to the three-dimensional optical sensor.

In an alternative embodiment, the light source can emit structured light that is the projection of a light pattern such as a plane, grid, or more complex shape at a known angle onto an object. The way that the light pattern deforms when striking surfaces allows vision systems to calculate the depth and surface information of the objects in the scene. Integral Imaging is a technique which provides a full parallax stereoscopic view. To record the information of an object, a micro lens array in conjunction with a high resolution optical sensor is used. Due to a different position of each micro lens with respect to the imaged object, multiple perspectives of the object can be imaged onto an optical sensor. The recorded image that contains elemental images from each micro lens can be electronically transferred and then reconstructed in image processing. In some embodiments the integral imaging lenses can have different focal lengths and the objects depth is determined based on if the object is in focus, a focus sensor, or out of focus, a defocus sensor. However, embodiments of the present invention are not limited to any particular type of three-dimensional optical sensor.

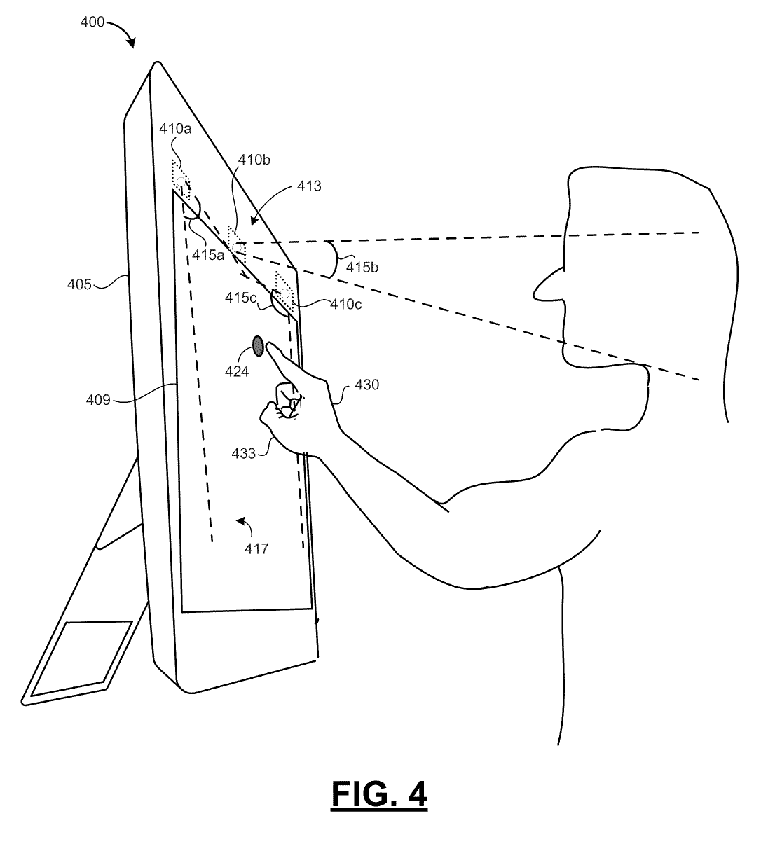

FIG. 4 illustrates a perspective view of the multi-camera system and the exemplary field of views of the optical sensors according to an embodiment of the present invention. In this illustrated embodiment, the display system 400 includes a display housing 405, a display panel 409, and three three-dimensional optical sensors 410a, 410b, and 410c. As shown here, optical sensors 410a and 410c are formed near top corners of the display panel along the upper perimeter 413, while optical sensor 410b is positioned along the upper perimeter 413 between the optical sensors 410a and 410c. Furthermore, optical sensors 410a and 410c have a field of view 415a and 415c respectively that faces in a direction that runs across the front surface 417 of the display panel 409, while optical sensor 410b has a field of view 415b that faces in a direction perpendicular to the front surface 417 of the display panel 409. Still further, and in accordance with one embodiment, optical sensors 410a and 410c are configured to capture measurement data of a detected object 430 within a predetermined distance (e.g. one meter) of the front surface 417 of the display panel 409. In contrast, optical sensor 410b may be configured to capture measurement data of the object 430 at a distance greater than the predetermined distance from the display panel 409 as indicated by the dotted lines of field of view 415b.

Furthermore, and as shown in the exemplary embodiment of FIG. 4, a touchpoint 424 may be registered as a user input based on the user physically touching, or nearly touching (i.e. hover), the display panel 409 with their hand 430. When touching a front surface the display panel 409 with a hand 430, however, the user's palm area 433 may also contact the touch surface of the display panel 409, thus disrupting and confusing the processor's registering of the intended touch input (i.e. touchpoint 424). The multi-camera system of the present embodiment is configured to create a detailed depth map of the object through use of three three-dimensional optical sensors 410a-410c so that the processor may recognize only the touchpoint 424 as a desired touch input and ignore the inadvertent touch caused by the user's palm area 433 resting on the display surface. Therefore, palm rejection capability is greatly improved utilizing the multi-camera system of the present embodiments.

As described above with reference to the embodiment depicted in FIG. 4, the multi-camera system may include two optical sensors 410a and 410c configured to look at volume close to the display panel 409, while a third optical sensor 410b is configured to look from a more central location out and away from the display panel 409. For example, optical sensors 410a and 410c can capture measurement data of the user's hand 430, while optical sensor 410b focuses on the position and orientation of the user's face and upper body. As such, any particular object can be imaged from more angles and at different depths than conventional methods, resulting in a more complete representation of the three-dimensional object and helping to reduce the possibility of object occlusion while also improving the palm rejection capability of the system.

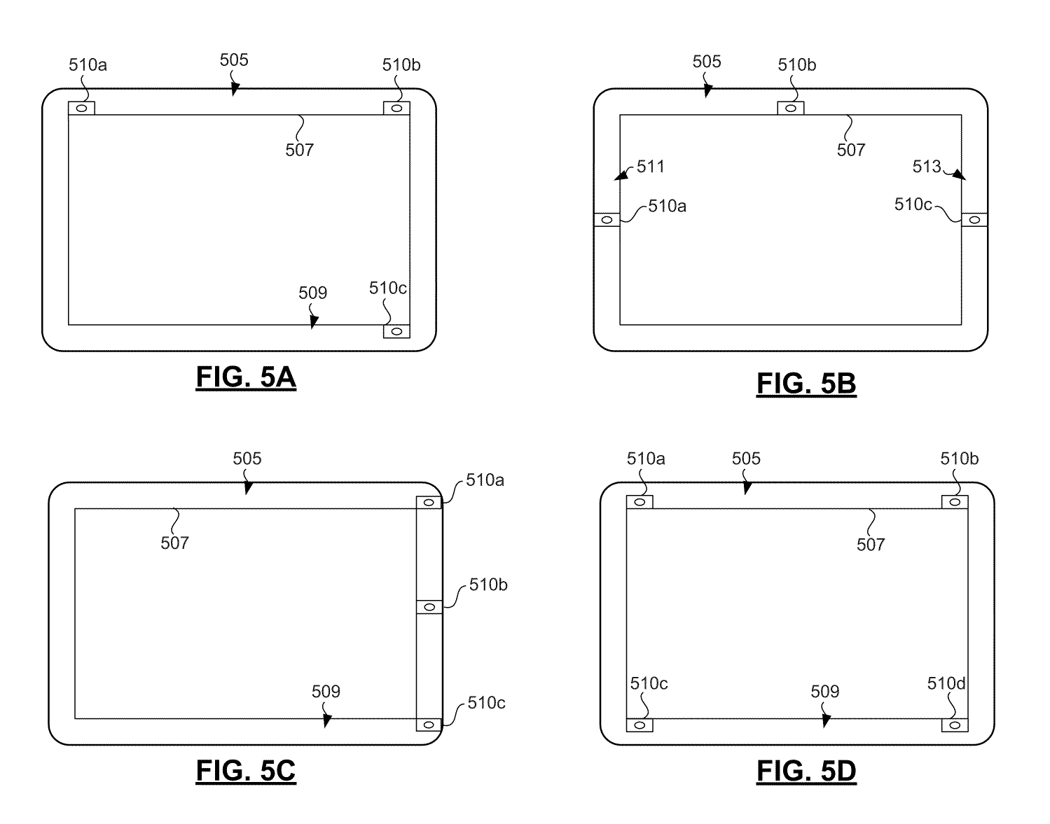

FIGS. 5A-5D illustrate alternative configurations of the multi-camera system according to embodiments of the present invention. As shown in exemplary embodiment of FIG. 5A, the multi-camera system may include two optical sensors 510a and 510b formed along the upper perimeter side 505 at opposite corners of the display panel 507 and one optical sensor 510c formed along the bottom perimeter side 509 of the display panel near a third corner. FIG. 5B depicts another multi-camera arraignment in which a first optical sensor 510a and a second optical sensor 510c are arranged along the left perimeter side 511 and the right perimeter side 513 respectively near a center area thereof, while a third optical sensor is formed along the central area of the upper perimeter side 505 of the display panel 507. Another configuration is depicted in FIG. 5C in which all three optical sensors 510a, 510b, and 510c are formed along the right perimeter side 513 of the display panel. In particular, first optical sensor 510a is positioned near a top corner of the display panel 507, a second optical sensor 510c is positioned near a bottom corner of the display panel 507, and a third optical sensor is positioned near a central area on the right perimeter side 513 of the display panel 507.

FIG. 5D depicts yet another exemplary embodiment of the multi-camera system. As shown in the illustrative embodiment, four three-dimensional optical sensors 510a-510d are positioned along the upper perimeter side 505 and lower perimeter side 509 near each corner of the display panel 507. However, the configuration and sensor arrangement of the multi-camera system are not limited by the above-described embodiments as many alternate configurations may be utilized to produce the same or similar advantages. For example, two sets of two three-dimensional optical sensors may be configured to break an imaging area of the display panel 507 up into two halves, reducing the distance any single sensor has to image. In yet another example, two optical sensors may have a field of view that focuses on objects closer to the display panel 507 while two more optical sensors may have a field of view for capturing measurement data of objects positioned further away from the display panel 507.

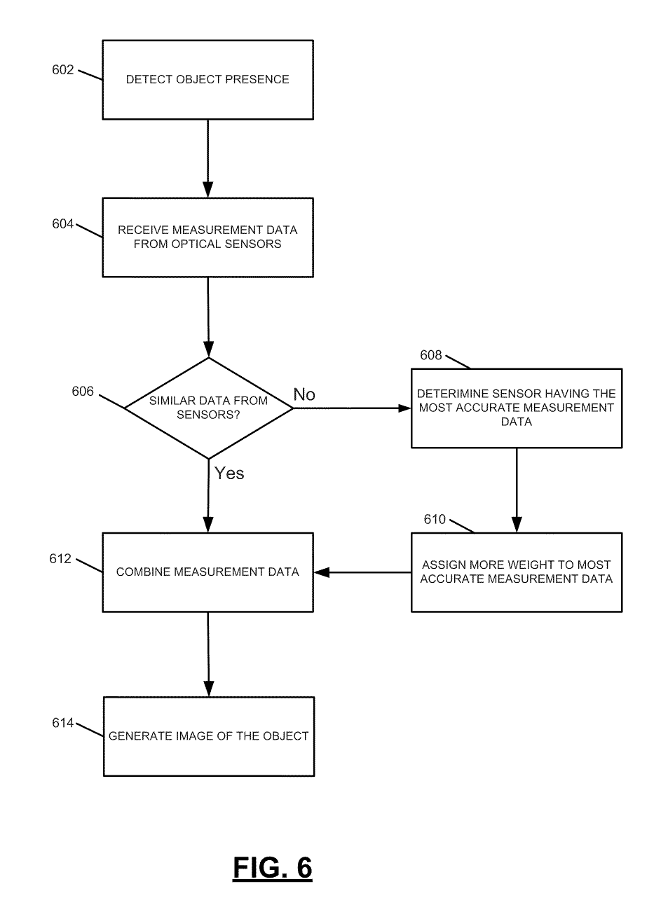

FIG. 6 illustrates the processing steps for the multi-camera system according to an embodiment of the present invention. In step 602, the processor detects the presence of an object, such as a user's hand or stylus, within a display area of the display panel based on data received from at least one three-dimensional optical sensor. In one embodiment, the display area is any space in front of the display panel that is capable of being captured by, or within the field of view of, at least one optical sensor. Initially, the received data includes depth information including the depth of the object from the optical sensor within its respective field of view. In step 604, the processor receives measurement data of the object including depth, height, width, and orientation information. However, the measurement data may also include additional information related to the object. Thereafter, in step 606, the processor determines if the measurement data received from the multiple optical sensors is relatively similar. That is, the processor compares the data from each optical sensor to determine and identify any particular data set that varies significantly from the other returned data sets. If the data is not similar, then the processor is configured to determine the particular data set and associated optical sensor having the varying measurement data in step 608. Then, in step 610, the determined data set is assigned more weight, or a higher value, than the measurement data sets returned from the other optical sensors. Next, in step 612, the measurement data from all the optical sensors is combined into a single data set, and in step 614, a highly detailed and accurate image of the detected object is generated by the processor based on the combined data set.

The multi-camera three-dimensional touchscreen environment described in the embodiments of the present invention has the advantage of being able to resolve three-dimensional objects in more detail. For example, more pixels are used to image the object and the object is imaged from more angles, resulting in a more complete representation of the object. The multiple camera system can also be used in a three-dimensional touch screen environment to image different volumes in front of the display panel. Accordingly, occlusion and palm rejection problems are drastically reduced, allowing a user's touch input to be correctly and accurately registered by the computer display system.

Furthermore, while the invention has been described with respect to exemplary embodiments, one skilled in the art will recognize that numerous modifications are possible. For example, although exemplary embodiments depict an all-in-one computer as the representative computer display system, the invention is not limited thereto. For example, the multi-camera system of the present embodiments may be implemented in a netbook, a tablet personal computer, a cell phone, or any other electronic device having a display panel.

Furthermore, the three-dimensional object may be any device, body part, or item capable of being recognized by the three-dimensional optical sensors of embodiments of the present embodiments. For example, a stylus, ball-point pen, or small paint brush may be used as a representative three-dimensional object by a user for simulating painting motions to be interpreted by a computer system running a painting application. That is, the multi-camera system and optical sensor arrangement thereof, is configured to detect and recognize any three-dimensional object within the field of view of a particular optical sensor.

In the foregoing description, numerous details are set forth to provide an understanding of the present invention. However, it will be understood by those skilled in the art that the present invention may be practiced without these details. Thus, although the invention has been described with respect to exemplary embodiments, it will be appreciated that the invention is intended to cover all modifications and equivalents within the scope of the following claims.

What is claimed is:

1. A display system comprising:
a display panel including a perimeter and configured to display images on a front side; and
at least three three-dimensional optical sensors arranged around the perimeter of the display panel, wherein each optical sensor is configured to capture measurement data of an object from a perspective different than a the perspective of the other optical sensors.

2. The system of claim 1, wherein the at least three optical sensors are arranged along one perimeter side of the display panel.

3. The system of claim 2, wherein a first optical sensor and a second optical sensor have a field of view in a direction that runs across the front side of the display panel and are configured to capture measurement data of the object within a predetermined distance of the front side of the display panel, and
wherein a third optical sensor has a field of view in a direction perpendicular to the front side of the display panel and is configured to capture the measurement data of an object positioned more than a predetermined distance away from the front side of the display panel.

4. The system of claim 3, wherein the first optical sensor is positioned along an upper perimeter side near a first corner of the front side of the display panel, the second optical sensor is positioned along the upper perimeter side near a second corner opposite the first corner of the display panel, and the third optical sensor is positioned in a central area of the upper perimeter side between the first corner and the second corner of the display panel.

5. The system of claim 3, wherein the first optical sensor is positioned along an upper perimeter side near a first corner of the front surface of the display panel, the second optical sensor is positioned along the upper perimeter side near a second corner opposite the first corner of the display panel, and the third optical sensor is positioned along a bottom perimeter side near a third corner of the display panel.

6. The system of claim 1, wherein display system includes four three-dimensional optical sensors.

7. The system of claim 6, wherein in a first optical sensor and a second optical sensor are arranged along an upper perimeter side on opposite corners of the front side of the display panel, and
wherein a third optical sensor and a fourth optical sensor are arranged along a bottom perimeter side near opposite corners of the front side of the display panel.

8. A method comprising:
detecting the presence of an object within a display area of a display panel via at least three three-dimensional optical sensors;
receiving measurement data of the object from the at least three optical sensors; and
determining from the measurement data of the three optical sensors the at least one optical sensor with the most accurate measurement data.

9. The method of claim 8, further comprising:
combining the measurement data from the at least three optical sensors to generate an image of the object.

10. The method of claim 9, wherein the step of combining the measurement data further comprises:
assigning more weight to the measurement data from the determined at least one optical sensor with the most accurate measurement data.

11. The method of claim 10, wherein the at least three optical sensors are arranged along one perimeter side of the display panel.

12. The method of claim 11, wherein a first optical sensor and a second optical sensor have a field of view in a direction that runs across a front surface of the display panel and are configured to capture measurement data of an object within a predetermined distance of the front surface of the display panel, and
wherein a third optical sensor has a field of view in a direction perpendicular to the display panel and is configured to capture measurement data of an object positioned more than a predetermined distance away from the display panel.

13. The method of claim 12, wherein the first optical sensor is positioned along an upper perimeter side near a first corner of the front surface of the display panel, the second optical sensor is positioned along the upper perimeter side near a second corner opposite the first corner of the display panel, and the third optical sensor is positioned in a central area of the upper perimeter side between the first corner and the second corner of the display panel.

14. The method of claim 12, wherein the first optical sensor is positioned along an upper perimeter side near a first corner of the display panel, the second optical sensor is positioned along the upper perimeter side near a second corner opposite the first corner of the display panel, and the third optical sensor is positioned along a bottom perimeter side near a third corner of the display panel.

15. The method of claim 8, wherein four three-dimensional optical sensors are utilized for capturing measurement data of the object.

16. The method of claim 15, wherein in a first optical sensor and a second optical sensor are arranged along an upper perimeter side on opposite corners of the display panel, and wherein a third optical sensor and a fourth optical sensor are arranged along a bottom perimeter side near opposite corners of the display panel.

17. A computer readable storage medium having stored executable instructions, that when executed by a processor, causes the processor to:
detect the presence of an object within a display area of a display panel via at least three three-dimensional optical sensors;
receive measurement data from the at least three optical sensors; and
determine from the measurement data of the three optical sensors the at least one optical sensor with the most accurate measurement data.

18. The computer readable storage medium of claim 17, wherein the executable instructions further cause the processor to:
combining the measurement data from the at least three optical sensors to generate an image of the object.

19. The computer readable storage medium of claim 18, wherein the executable instructions of combining the measurement data further comprises instructions to:
assign more weight to the measurement data from the at least one optical sensor with the most accurate measurement data.

20. The computer readable storage medium of claim 19, wherein the at least three optical sensors are arranged along one perimeter side of the display panel,
wherein a first optical sensor and a second optical sensor have a field of view in a direction that runs across the front surface of the display panel and are configured to capture measurement data of an object within a predetermined distance of the fronts surface of the display panel, and
wherein a third optical sensor has a field of view in a direction perpendicular to the front surface of the display panel and is configured to capture measurement data of an object positioned more than a predetermined distance away from the display panel.
